(19) United States
(12) Patent Application Publication
(10) Pub. No.: US 2015/0278872 A1
(43) Pub. Date: Oct. 1, 2015

(54) Method and Electronic Device for Distributing Advertisements

(71) Applicant: GOOGLE TECHNOLOGY HOLDINGS LLC, Mountain View, CA (US)

(72) Inventors: Krishnan Raghavan, Bangalore (IN); Vignesh Karthik M. Mohan, Bangalore (IN); Pralabh Kumar, New Delhi (IN)

(21) Appl. No.: 14/311,971

(22) Filed: Jun. 23, 2014

Related U.S. Application Data
(60) Provisional application No. 61/972,309, filed on Mar. 29, 2014.

(51) Int. Cl. G06Q 30/02

(52) U.S. Cl. CPC G06Q 30/0267; G06Q 30/0257; G06Q 30/0261

(57) ABSTRACT

An electronic device transmits a user profile to a server. The electronic device receives a voice call from the server, where audio content of the voice call includes an advertisement related to the user profile. The electronic device automatically accepts the received voice call based on predefined settings. The electronic device then records the audio content of the voice call. The electronic device extracts the advertisement from the recorded audio content and stores the extracted advertisement in a memory of the electronic device. In another implementation, the electronic device receives a text message from the server, where content of the text message includes a characteristic of the advertisement. The electronic device then associates and stores the received characteristic with the stored advertisement.

### CROSS-REFERENCE TO RELATED APPLICATIONS

The present application claims priority to U.S. Provisional Patent Application No. 61/972,309, filed Mar. 29, 2014, the contents of which are incorporated herein by reference.

### TECHNICAL FIELD

The present disclosure is related generally to methods and electronic devices for distributing advertisements.

### BACKGROUND

Modern day mobile advertisement distribution models typically rely on cellular data or Wi-Fi connections. However, there are many areas of the world where such connections are not always available or reliable. In such areas, more traditional ways of delivering advertisements are often used, and typically involve an advertiser calling a consumer to play an advertisement. The advertiser may also send text messages to the consumer. These techniques are often ineffective. For one thing, they do not fit into the consumer's regular usage. Instead, these advertisements force the consumer to spend extra time and effort viewing them or listening to them. Furthermore, advertisements received via voice calls are short-lived, i.e., when the voice call is disconnected, the advertisement is gone forever. Another voice-based advertisement distribution technique plays advertisements as ringback tones. This technique, however, requires support from cellular carriers.

### BRIEF DESCRIPTION OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a block diagram of a representative advertisement distribution system in which the methods of this disclosure may be practiced;

FIG. 2 is a generalized schematic of a representative electronic device;

FIG. 3 is a representative diagram of recorded audio content of a voice call, according to an embodiment;

FIG. 4 illustrates example content of an advertisement distribution text message, according to an embodiment;

FIG. 5 is a process flow diagram showing a procedure carried out according to an embodiment of the disclosure; and

FIG. 6 is a process flow diagram showing a procedure carried out according to an embodiment of the disclosure.

### DETAILED DESCRIPTION

Turning to the drawings wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

According to various embodiments of the disclosure, methods to push advertisements to an electronic device (e.g., a traditional cell phone, a modern smartphone, a wearable device such as a smartwatch, or other kind of mobile device) with no cellular data or Wi-Fi connections and with no carrier involvement are described. The embodiments may provide advertisers with an opportunity to target consumers without data connection more effectively than traditional advertisement distribution models. Further, the methods described herein may offer offline storage for advertisements, allowing them to be retrieved and used at the appropriate time.

An advertisement distribution method according to one embodiment includes: pushing advertisements into an electronic device without cellular data or Wi-Fi connections and without carrier involvement; retrieving the advertisements at the right opportunity; displaying and/or playing the advertisements to a user of the electronic device; allowing the user to query for advertisements and offers; allowing the user to distribute advertisements to other consumers; and reporting statistics back to the server for rewards and/or other data collection.

In an embodiment, an electronic device transmits a user profile to a server via text message. The electronic device receives a voice call from the server. Audio content of the voice call includes an advertisement related to the user profile. The electronic device accepts the received voice call based on predefined, configurable settings, records the audio content of the voice call, extracts one or more advertisements from the recorded audio content, and stores the extracted advertisement in its memory.

In another embodiment, the electronic device receives a text message from the server. The content of the text message includes a characteristic of one or more advertisements. The electronic device then associates and stores the characteristic with the stored advertisement. The electronic device may then use the audio content (e.g., voice ads) along with the associated text to play and/or distribute advertisement to the user of the device or to remote users.

In yet another embodiment, an electronic device includes a transceiver, a processor communicatively coupled to the transceiver, and a memory communicatively coupled to the processor. The transceiver is configured to transmit a user profile to a server and receive a voice call from the server. Audio content of the voice call includes an advertisement related to the user profile. The processor is configured to accept the received voice call based on predefined settings, record the decoded audio content of the voice call, and extract the advertisement from the recorded audio content. The memory is configured to store the advertisement.

In still another embodiment, the transceiver is further configured to receive a text message from the server, in which content of the text message includes a characteristic of the advertisement. The processor is further configured to associate the received characteristic with the stored advertisement. The memory is further configured to store the received characteristic with the stored advertisement.

In another embodiment, the processor is further configured to select the advertisement from multiple advertisements stored in the memory and distribute the advertisement during a voice call.

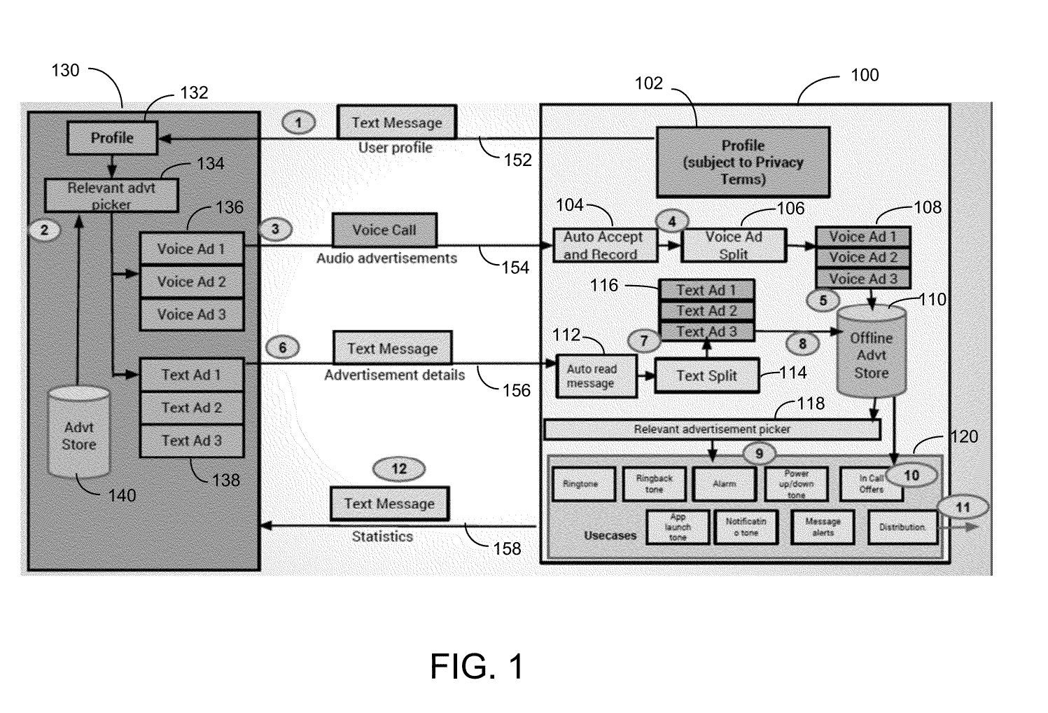

FIG. 1 is an overview of a representative advertisement distribution system in which the methods of this disclosure may be practiced. The advertisement distribution system includes an electronic device 100 (e.g., a mobile device) and a server 130. The actions carried out by the different components of the system are numbered, and will be described as “operations.”

At operation 1, the electronic device 100 retrieves a user profile 102 (subject to privacy terms) from memory and transmits the user profile 102 via text message 152 to the server 130. The electronic device 100 may send the text message 152 to a preconfigured toll-free number assigned to the server 130. The server 130 receives the user profile 102 and stores it as user profile 132.

At operation 2, based on the user profile 132 stored on the server 130, a relevant advertisement picker 134 selects or shortlists relevant audio advertisements (“Voice Ads”) and possibly associated text advertisements (“Text Ads”). The Voice Ads and Text Ads are stored in an advertisement storage unit 140 of the server 130.

Once the relevant Voice Ads 136 are shortlisted by the server 130, at operation 3, the server 130 makes a voice call 154 to the electronic device 100 (e.g., at a predefined time). The voice call 154 may include one Voice Ad, or a set of Voice Ads 136 with spacing or a predefined signal between each Voice Ad.

Upon receiving the voice call 154, the electronic device 100 automatically accepts the voice call 154 (e.g., without alerting the user) and records the audio content 104 of the voice call 154 (i.e., the Voice Ads on voice stream). Then at operation 4, the electronic device 100 splits the audio content 104 into individual Voice Ad content 106. The electronic device 100 then stores the split Voice Ad content 108 into an offline advertisement storage unit 110 (e.g., a memory) at operation 5.

At operation 6, corresponding to the Voice Ads 136, the server 130 immediately transmits a text message 156 that identifies the characteristics (e.g., tags) of each Voice Ad 136 that was transmitted earlier in the voice call 154. The characteristics include whether the Voice Ad 136 is an advertisement for local use by the electronic device 100 (e.g., ringtone, call back tone, alarm, etc.), whether the Voice Ad 136 is distributable, the topic or genre the Voice Ad 136 covers (e.g., cars, movies, retail, etc.), or the text form of the Voice Ad 136.

Upon receiving the text message 156, the electronic device 100 automatically reads the received text message 112 (e.g., without displaying the received text message 112 to the user). Then at operation 7, the electronic device 100 splits content 114 of the received text message 112 into individual Text Ad content 116. The electronic device 100 then stores the individual Text Ad content 116 into the offline advertisement storage unit 110 at operation 8. In more detail, the electronic device 100 associates the individual Text Ad content 116 with the Voice Ad content 108 already stored in the advertisement storage unit 110. For example, Text Ad content 1 is associated and/or stored with Voice Ad content 1, Text Ad content 2 is associated and/or stored with Voice Ad content 2, and Text Ad content 3 is associated and/or stored with Voice Ad content 3. Thus, a data store of advertisements and their profiles or characteristics is made locally available on the electronic device 100. This data store may also have voice advertisements without related text advertisements and text advertisements without related voice advertisements.

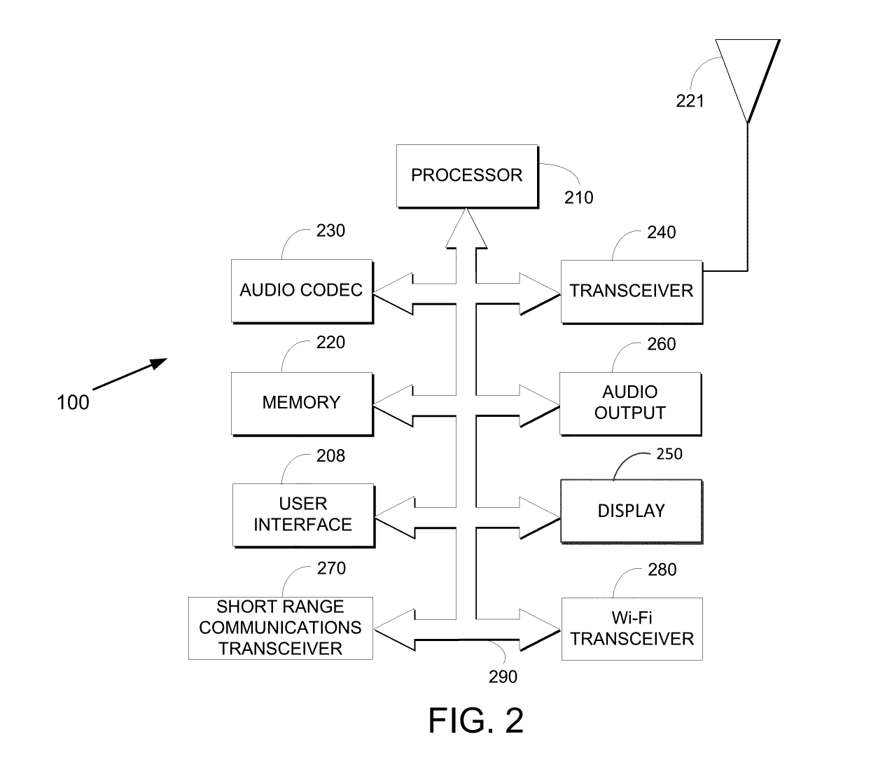

FIG. 2 illustrates a generalized schematic of the electronic device 100 of FIG. 1n accordance with an embodiment of the disclosure. The electronic device 100 includes a user interface 208, a processor 210, a memory 220 (which can be implemented as volatile memory or non-volatile memory), an audio codec 230, a transceiver 240, a display 250 (e.g., an organic light-emitting diode display), an audio output 260 (e.g., a speaker or audio port), an antenna 221, a short range communications transceiver 270, and a Wi-Fi transceiver 280. Each of these elements is communicatively linked to one another via one or more data pathways 290.

Possible implementations of the data pathways 290 include wires, conductive pathways on a microchip, and wireless connections. Possible implementations of the processor 210 include a microprocessor and a computer.

During operation of the electronic device 100, the transceiver 240 receives data from the processor 210 and transmits Radio Frequency (“RF”) signals representing the data via the antenna 221 connected to it. Similarly, the transceiver 240 receives RF signals via the antenna 221, converts the signals into the appropriately formatted data, and provides the data to the controller 210. The transceiver 240 may include a cellular transceiver to conduct cellular communications over a cellular network (e.g., a Long Term Evolution network). In many of the embodiments described herein, it will be assumed that the transceiver 240 is a cellular baseband chipset, and that it capable of communicating over a cellular voice network. It may also be capable of communicating using a short message service (“SMS”) of the cellular network.

The short range communications transceiver 270 is configured to conduct non-cellular wireless communications. In various embodiments, the short range communications transceiver 270 may include for example, a wireless transceiver employing ad hoc communication technologies such as HomeRF (radio frequency), Home Node B (3G femtocell), Bluetooth and/or other wireless communication technologies such as infrared technology.

The Wi-Fi transceiver 280 is a wireless local area network (WLAN) transceiver configured to conduct Wi-Fi communications in accordance with the IEEE 802.11x standard.

The processor 210 retrieves instructions and data from the memory 220 and, using the instructions and data, provides outgoing data to, or receives incoming data from the transceivers 240, the short range communications transceiver 270, and/or the Wi-Fi transceiver 280.

The memory 220 has stored thereon hardware and software information about the electronic device 100. The memory 220 also has stored thereon algorithms, which when executed by the processor 210, perform methods of receiving, storing, and distributing advertisement described in the present disclosure. The memory 220 may include the offline advertisement storage unit 110 as shown in FIG. 1.

The audio codec 230 (e.g., a hardware audio codec) translates voice communication (e.g., human-perceivable sound) received over a voice network (cellular or otherwise) via the transceiver 240 into a format (such as an MP3 format) that can be played over a speaker or stored in the memory 220. Conversely, the audio codec 230 converts sound input from a user into voice data having a format that allows the data to be transmitted via the transceiver 240 over the voice network.

The methods described herein are implemented when the transceiver 240 and/or the Wi-Fi transceiver 280 are turned off or are not receiving data (e.g., no cellular data or Wi-Fi connections), but the transceiver 240 may be receiving voice calls and possibly text messages. The methods described herein are also implemented on devices without cellular data (e.g., general packet radio service, 3G data, or 4G data) or Wi-Fi connection capabilities. In other words the advertisement distribution methods disclosed herein may be implemented in any electronic device having mobile voice and text message capabilities.

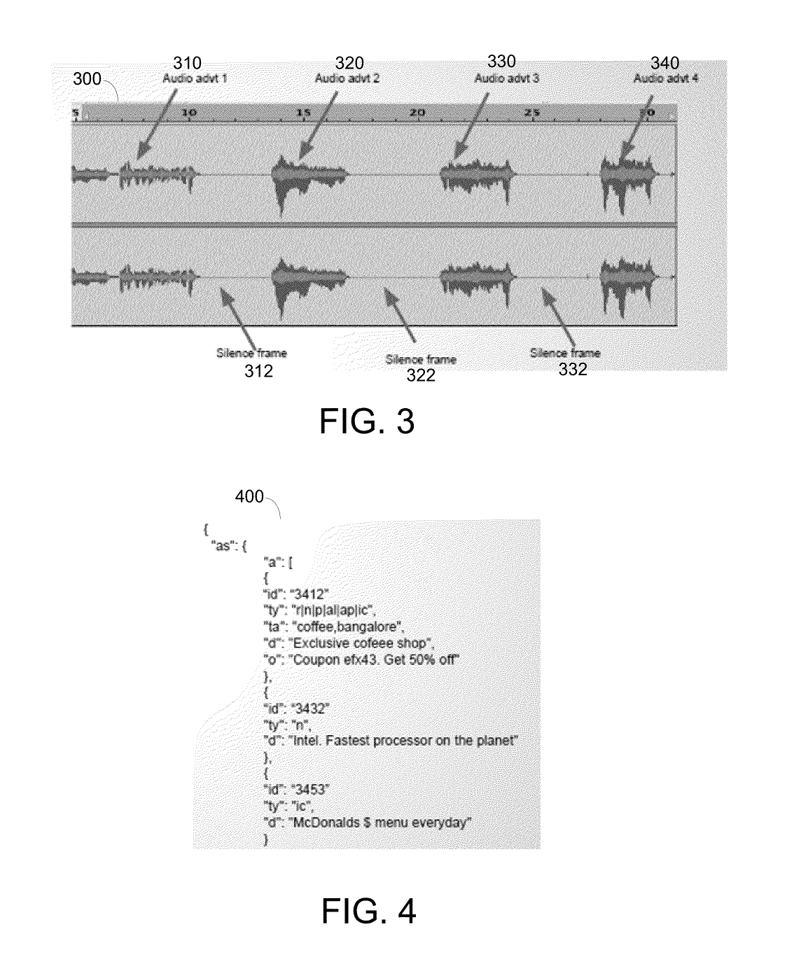

FIG. 3 is a representative diagram of recorded audio content 300 of a voice call, according to an embodiment. As shown, the recorded audio content 300 includes four audio or voice advertisements: audio advertisement 310, audio advertisement 320, audio advertisement 330, and audio advertisement 340. To assist the electronic device 110 in extracting the content of the audio advertisements, silence frames are provided as spacing between each of the audio advertisements. In FIG. 3, silence frame 312 is provided between audio advertisement 310 and audio advertisement 320, silence frame 322 is provided between audio advertisement 320 and audio advertisement 330, and silence frame 332 is provided between audio advertisement 330 and audio advertisement 340. Based on silent frames 312, 322, and 332, the processor of the electronic device 100 may extract each individual audio advertisement from the recorded audio content 300.

FIG. 4 illustrates representative content of an advertisement distribution text message 400, according to an embodiment. After receiving the voice call containing the audio advertisements, the electronic device 100 may receive a text message that contains description of the corresponding audio advertisement that was received via the voice call. In an embodiment, the format of the text message allows the server 130 to specify the characteristics of the advertisement, for example, the usage of the audio advertisement (e.g., as a ringtone, a notification, a power on/off sound, an alarm, an application launch/close sound, for use during a call, etc.), tags or topic of the advertisement, or a short text of the advertisement and offers. Each characteristic specifies the right opportunity at which the advertisement should be used. An example of the text message containing such advertisement characteristics is shown as text message 400.

Referring back to FIG. 1, once the Text Ad content 116 and the Voice Ad content 108 are stored in the storage unit 110, the advertisements may be played or displayed at the right opportunities. Operation 9 illustrates various use cases for playing and displaying the advertisements.

For example, an advertisement may be played during an outgoing call. When a user makes a voice call, a short advertisement is played over the speaker or on the user's earpiece (or Bluetooth® headset) or external speaker of an accessory (e.g., a Bluetooth® accessory) until the voice call is picked up or rejected by the recipient.

An advertisement may also be played during an incoming call. When the user receives an incoming call, the ring tone of the electronic device 100 is changed to a musical advertisement. In an embodiment, the electronic device 100 may alternate between the user's ringtone and the musical advertisement. This also allows the advertisement to be distributed to others around the user, as they may hear the musical advertisement when the user receives the call.

Furthermore, on the incoming call screen displayed on the display 250 of the electronic device, when an advertisement is played as a ringtone, a short description or text of the advertisement is displayed. If there is any offer presented in the description, the user can click on the offer to get the offer (e.g., a coupon) on a notification bar or as a message in the user's messaging application.

In another embodiment, an advertisement may be played or displayed when a call is on hold.

In still another embodiment, an advertisement may replace any notification of the electronic device 100. For example, when an alarm is played, an advertisement may be played instead. Optionally, the advertisement may be alternated with the chosen alarm tone. In another example, when the battery of the electronic device 100 is low, an advertisement from a battery company may be played. In another instance, when an incoming text message is received, a short advertisement can be played instead of the text message notification sound. In still another instance, when the electronic device 100 powers on and/or off, a product theme advertisement may be played.

Referring still to FIG. 1, at operation 10, an advertisement query may be made during a voice call. The user may query for offers or coupons by speaking a query during

At operation 11, the electronic device 100 may distribute the advertisements stored in its offline advertisement storage unit 110. In an embodiment, when a user receives an incoming call, the electronic device presents the user with an option to “Accept call and play advertisement” to the caller. The user is presented with a list of relevant advertisements, and the user may choose one among the list to play to the caller as soon as the call is connected. Using this method, advertisements are distributed to landlines, i.e., no software or application is required for the caller to receive the advertisement.

In another embodiment, an advertisement can be played automatically to the caller when the user accepts the incoming call. The advertisement may be selected based on where the originating location of the call. For example, if the incoming call is from Kerala, India, an advertisement in the locale specific to Kerala can be played automatically when the electronic device receives the call.

In other embodiments, an advertisement may be played during the conversation. In still other embodiments, the advertisement may be distributed via NFC between the user's device and the users' friends' devices, via mesh network, or via social media.

At operation 12, the electronic device 100 reports statistics on the usage of the advertisement to the server 130 via text message 158. At regular intervals, the electronic device 100 reports the statistics of each advertisement (e.g., the number of times played, the number of times distributed, etc.) via text message 158 to a preconfigured toll free number. The reported statistics is subsequently used to reward the user for listening, viewing, and distributing the advertisement. As an incentive for the user, the reward points may be credits such as additional minutes, free data, or even a portion of the revenue generated due to such advertisement distribution.

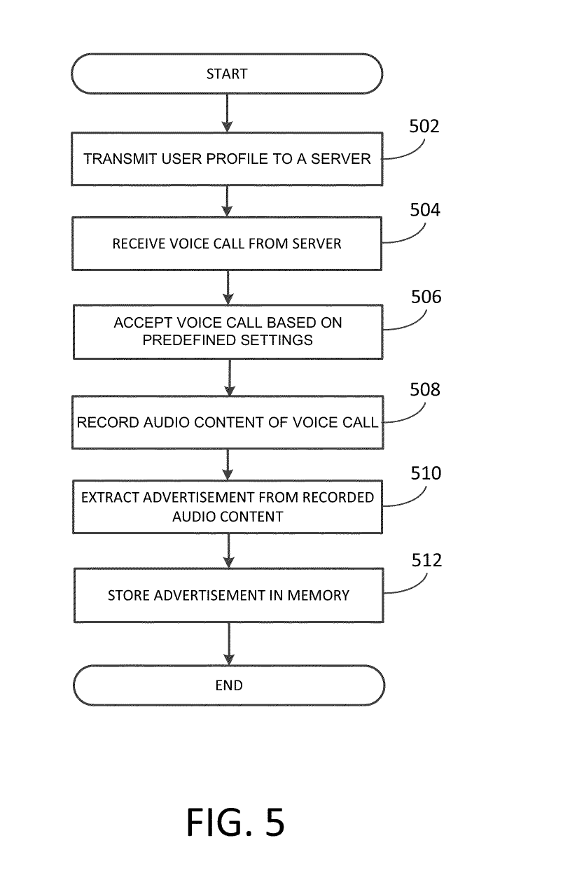

FIG. 5 is a flowchart showing procedure 500 carried out according to an embodiment of the disclosure. The procedure 500 is carried out by an electronic device, e.g., the electronic device 100 shown in FIG. 1.

At step 502, the transceiver 240 of the electronic device 100 transmits a user profile to a server. At step 504, the transceiver 240 receives a voice call from the server 130, where audio content of the voice call includes an advertisement related to the user profile.

Upon receiving the voice call, the processor 210 of the electronic device accepts the received voice call based on predefined settings at step 506. The processor 210 then records the audio content of the voice call at step 508. Next, at step 510, the processor 210 extracts the advertisement from the recorded audio content. The processor 210 then stores the extracted advertisement in the memory at step 512.

At step 504, the electronic device 100 may automatically accept the received voice call based on the predefined settings (e.g., without alerting the user of the call), so that the electronic device receives the entire audio content of the voice call with minimal interruption. The predefined settings may include a time of the day or a day of the week. For example, the server may push advertisements to the electronic device on a daily or weekly basis, where the server may make the voice call to the electronic device at a time when the user is not using the electronic device (e.g., 2 AM). Optically, the predefined settings may be set by the electronic device, the server, or the user. Additionally, the server may retry later (according to its configuration) if the electronic device 100 is not in a position to auto-accept calls (e.g., it is in another call, is not reachable, etc.).

In an embodiment, the transceiver 240 of the electronic device 100 also receives a text message from the server 130, which it provides to the processor 210. The content of the text message may include a characteristic of the advertisement. The processor 210 then associates and stores the received characteristic with the stored advertisement in the memory 220. The characteristic of the advertisement may include a usage type of the advertisement, a topic of the advertisement, text of the advertisement, or distribution type of the advertisement.

The electronic device 100 may also receive an advertisement query from the user and retrieve relevant advertisements based on the query. In one embodiment, the electronic device 100 receives a spoken advertisement query (e.g., via a microphone or other audio input device). The processor 210 then locates, in the memory 220, the advertisement that is related to the spoken advertisement query. The electronic device 100 may then play the advertisement via the audio output 260, or display the advertisement on the display 250.

In another embodiment, the electronic device 100 receives a written advertisement query (e.g., via the inter interface 208, an input unit, such as a keypad, touch screen of the display 250, etc.). The processor 210 then locates, in the memory 220, the advertisement that is related to the written advertisement query. The electronic device 100 may then play the advertisement via the audio output 260, or display the advertisement on the display 250.

The electronic device 100 may play the advertisement via the audio output 260 when an outgoing call is placed. In another embodiment, the electronic device 100 plays the advertisement via the audio output 260 when an incoming call is received. In still another embodiment, the electronic device 100 displays text of the advertisement on the display 250 when the incoming call is received. In yet another embodiment, the electronic device 100 plays the advertisement via the audio output 260 when a voice call is on hold. In yet another embodiment, the electronic device plays the advertisement via the audio output 260 instead of a notification sound.

The electronic device 100 may also distribute the advertisement. In an embodiment, the electronic device 100 selects the advertisement from a multiple

In another embodiment, the electronic device 100 selects the advertisement by displaying multiple advertisements on the display 250 incoming call is received, and then receives a user selection of the advertisement. In still another embodiment, the electronic device 100 selects the advertisement based on a location of the caller.

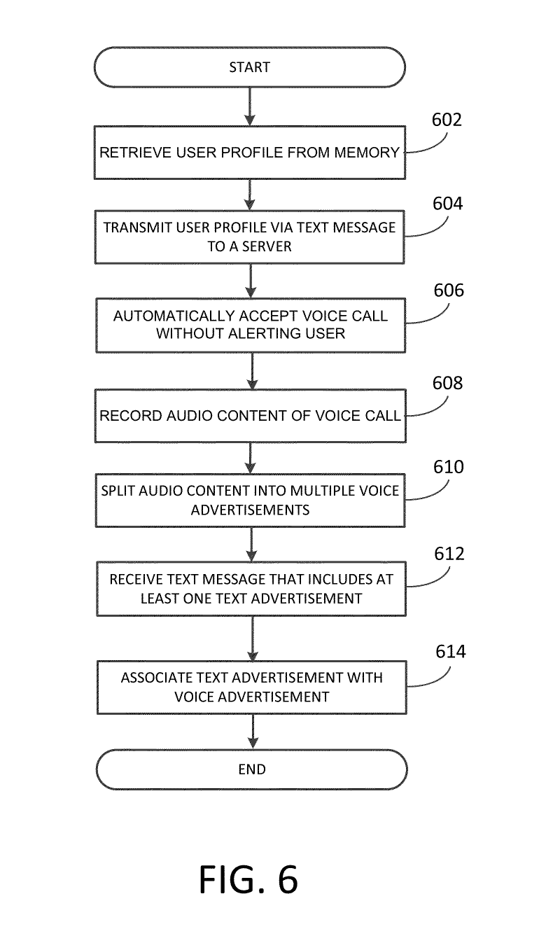

FIG. 6 is a flowchart showing procedure 600 carried out according to another embodiment of the disclosure. The procedure 600 is carried out by an electronic device, e.g., the electronic device 100 shown in FIG. 1. At step 602, the electronic device 100 retrieves a user profile from memory. At step 604, the electronic device 100 transmits the user profile to the server 130. At step 606, the electronic device 100 automatically accepts a voice call from the server without alerting the user. At step 608, the electronic device 100 records the audio content of the voice call. At step 610, the electronic device 100 splits the audio content into multiple voice advertisements. At step 612, the electronic device 100 receives a text message from the server 130. The text message includes at least one text advertisement that relates to at least one of the voice advertisements. At step 614, the electronic device 100 associates, in memory, the text advertisement with the voice to which it relates.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method in an electronic device, the method comprising:
transmitting a user profile to a server;
receiving a voice call from the server, wherein audio content of the voice call comprises an advertisement related to the user profile;
automatically accepting the received voice call based on predefined settings;
recording the audio content of the voice call;
extracting the advertisement from the recorded audio content; and
storing the extracted advertisement in a memory of the electronic device.

2. The method of claim 1, further comprising:
receiving a text message from the server, wherein content of the text message comprises a characteristic of the advertisement; and
associating and storing the received characteristic with the stored advertisement.

3. The method of claim 2, wherein the characteristic of the advertisement is selected from the group consisting of a usage type of the advertisement, a topic of the advertisement, text of the advertisement, and distribution type of the advertisement.

4. The method of claim 2, further comprising:
receiving a spoken advertisement query;
locating, in the memory of the electronic device, the advertisement that is related to the spoken advertisement query; and
playing the advertisement via an audio output device of the electronic device, or displaying the advertisement on a display of the electronic device.

5. The method of claim 2, further comprising:
receiving a written advertisement query;
locating, in the memory of the electronic device, the advertisement that is related to the written advertisement query; and
playing the advertisement via an audio output device of the electronic device, or displaying the advertisement on a display of the electronic device.

6. The method of claim 2, further comprising playing the advertisement via a speaker of the electronic device or a speaker of an accessory of the electronic device when an outgoing call is placed, when an incoming call is received, when a voice call is on hold, or instead of a notification sound.

7. The method of claim 6, further comprising displaying text of the advertisement on a display of the electronic device when the incoming call is received.

8. The method of claim 2, further comprising:
selecting the advertisement from a plurality of advertisements stored in the memory of the electronic device; and
distributing the advertisement during a voice call.

9. The method of claim 8, wherein the distributing of the advertisement comprises playing the advertisement to a caller when an incoming call from the caller is received or during the incoming call.

10. The method of claim 9, wherein the selecting of the advertisement comprises:
displaying the plurality of advertisements on a display of the electronic device when the incoming call is received; and
receiving a user selection of the advertisement.

11. The method of claim 9, wherein the selecting of the advertisement comprises selecting the advertisement based on a location of the caller.

12. The method of claim 8, wherein the distributing of the advertisement comprises playing the advertisement to one or more callers in a conference call.

13. The method of claim 2, further comprising transmitting statistics of the advertisement to the server via text message.

14. The method of claim 1, wherein the electronic device does not have cellular data or Wi-Fi connections.

15. The method of claim 1, wherein the audio content of the voice call comprises a plurality of advertisements related to the user profile.

16. The method of claim 1, wherein:
the accepting of the received voice call comprises automatically accepting the received voice call based on the predefined settings; and
the predefined settings comprises a time of the day or a day of the week.

17. An electronic device comprising:
a transceiver configured to:
transmit a user profile to a server;
receive a voice call from the server, wherein audio content of the voice call comprises an advertisement related to the user profile;
a processor communicatively coupled to the transceiver and configured to:
accept the received voice call based on predefined settings;
record the decoded audio content of the voice call;
extract the advertisement from the recorded audio content; and
a memory communicatively coupled to the processor and configured to store the advertisement.

18. The electronic device of claim 17, wherein:
the transceiver is further configured to receive a text message from the server,
wherein content of the text message comprises a characteristic of the advertisement;
the processor is further configured to associate the received characteristic with the stored advertisement; and
the memory is further configured to store the received characteristic with the stored advertisement.

19. The device of claim 17, wherein the processor is further configured to:
select the advertisement from a plurality of advertisements stored in the memory; and
distribute the advertisement during a voice call.

20. A method in an electronic device, the method comprising:
retrieving a user profile from a memory of the electronic device;
transmitting the user profile to a server;
automatically accepting a voice call from the server without alerting a user of the electronic device;
recording the audio content of the voice call;
splitting the audio content into a plurality of voice advertisements;
receiving a text message from the server, wherein the text message includes at least one text advertisement that relates to at least one of the plurality of voice advertisements; and
associating, in memory, the text advertisement with the voice advertisement to which it relates.
